(19) United States
(12) Patent Application Publication
(10) Pub. No.: US 2023/0121905 A1
(43) Pub. Date: Apr. 20, 2023

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventor: HIROSHI ICHIKI, KANAGAWA (JP)

(21) Appl. No.: 17/906,218

(22) PCT Filed: Mar. 11, 2021
(86) PCT No.: PCT/JP2021/009793

§ 371 Date: Sep. 13, 2022

(30) Foreign Application Priority Data
Mar. 26, 2020 (JP) 2020-056037

(51) Int. Cl. G06V 10/74; G06T 7/50; G06T 7/62; G06V 10/764

(52) U.S. Cl. CPC G06V 10/761; G06T 7/50; G06T 7/62; G06V 10/764; G06V 2201/07; G06T 2207/30252

(57) ABSTRACT

An information processing apparatus according to an embodiment of the present technology includes an acquisition unit and a recognition unit. The acquisition unit acquires image information and distance information with respect to a sensing region. The recognition unit performs integration processing according to a distance to a target object present in the sensing region and recognizes the target object by using the image information and the distance information as an input. Moreover, the integration processing is recognition processing in which first recognition processing using the image information as an input and second recognition processing using the distance information as an input are integrated.

### TECHNICAL FIELD

The present technology relates to an information processing apparatus, an information processing method, and a program that can be applied to object recognition.

### BACKGROUND ART

Patent Literature 1 has disclosed a simulation system using CG images. In this simulation system, images extremely similar to actually taken images are artificially generated, and the number of samples of machine learning is thus increased. Accordingly, the efficiency of the machine learning is enhanced, and the recognition rate of an object to be imaged is improved (paragraphs [0010], [0022], and the like in specification of Patent Literature 1).

### CITATION LIST

### Patent Literature

Patent Literature 1: Japanese Patent Application Laid-open No. 2018-60511

### DISCLOSURE OF INVENTION

### Technical Problem

It is thus desirable to provide a technology capable of improving the recognition accuracy for a target object.

In view of the above-mentioned circumstances, it is an objective of the present technology to provide an information processing apparatus, an information processing method, and a program that are capable of improving the recognition accuracy for a target object.

### Solution to Problem

In order to accomplish the above-mentioned objective, an information processing apparatus according to an embodiment of the present technology includes an acquisition unit and a recognition unit.

The acquisition unit acquires image information and distance information with respect to a sensing region.

The recognition unit performs integration processing according to a distance to a target object present in the sensing region and recognizes the target object by using the image information and the distance information as an input.

Moreover, the integration processing is recognition processing in which first recognition processing using the image information as an input and second recognition processing using the distance information as an input are integrated.

Moreover, the integration processing is recognition processing in which first recognition processing using the image information as an input and second recognition processing using the distance information as an input are integrated.

In this information processing apparatus, the integration processing according to the distance to the target object is performed by using the image information and the distance information with respect to the sensing region as the input. The integration processing is the recognition processing in which the first recognition processing using the image information as the input and the second recognition processing using the distance information as the input are integrated. Accordingly, the recognition accuracy for a target object can be improved.

The recognition unit may recognize the target object by using the first recognition processing as a base in a case where the distance to the target object is relatively short.

The recognition unit may recognize the target object by using the second recognition processing as a base in a case where the distance to the target object is relatively long.

Each of the first recognition processing and the second recognition processing may be recognition processing using a machine learning algorithm.

The first recognition processing may be recognition processing to recognize the target object on the basis of an image feature obtained from the image information. In this case, the second recognition processing may be processing to recognize the target object on the basis of a shape obtained from the distance information.

The integration processing according to the distance to the target object may be recognition processing using a machine learning algorithm.

The integration processing according to the distance to the target object may be recognition processing based on a machine learning model learned from training data including information related to the distance to the target object.

The information related to the distance to the target object may be a size of a region of the target object included in each of the image information and the distance information.

The training data may be generated in such a manner that the image information and the distance information are classified into a plurality of classes and labelling is performed for each of the plurality of classes classified.

The classification of the plurality of classes may be classification based on a size of a region of the target object included in each of the image information and the distance information.

The training data may include the image information and the distance information generated by computer simulation.

The integration processing may be processing to integrate, with weighting according to a distance to the target object, a recognition result of the first recognition processing using the image information as the input and a recognition result of the second recognition processing using the distance information as the input.

The recognition unit may set the weighting of the recognition result of the first recognition processing to be relatively high in a case where the distance to the target object is relatively short, set the weighting of the recognition result of the second recognition processing to be relatively high in a case where the distance to the target object is relatively long, and perform the integration processing.

The integration processing may be processing to output, in accordance with a distance to the target object, a recognition result of the first recognition processing using the image information as the input or a recognition result of the second recognition processing using the distance information as the input.

The recognition unit may output the recognition result of the first recognition processing in a case where the distance to the target object is relatively short and output the recognition result of the second recognition processing in a case where the distance to the target object is relatively long.

The recognition unit may output information related to a region in which the target object in the sensing region is present, as the recognition result.

An information processing method according to an embodiment of the present technology is an information processing method to be executed by a computer system, including:

a step of acquiring image information and distance information with respect to a sensing region; and

a step of performing integration processing according to a distance to a target object present in the sensing region and recognizing the target object by using the image information and the distance information as an input.

Moreover, the integration processing is recognition processing in which first recognition processing using the image information as an input and second recognition processing using the distance information as an input are integrated.

An information processing method according to an embodiment of the present technology is a program that causes a computer system to execute the above-mentioned information processing method.

### BRIEF DESCRIPTION OF DRAWINGS

FIG. 1 A schematic diagram for describing a configuration example of an object recognition system according to an embodiment.

FIG. 2 A schematic diagram for describing a variation example of integration processing.

FIG. 3 A schematic diagram for describing a variation example of integration processing.

FIG. 4 An external view showing a configuration example of a vehicle.

FIG. 5 Table and graph showing an example of a correspondence relationship between a distance to a vehicle present in a sensing region and the number of pixels of the vehicle in image information.

FIG. 6 A graph showing a distribution of the number of samples and a recall value in a case where training data obtained by setting a label (BBox) manually input in image information obtained by actual measurement was used.

FIG. 7 A graph showing a distribution of the number of samples and a recall value in a case where training data (image information and label) obtained by CG simulation was used.

FIG. 8 A graph showing an example of a recall value of each of a first machine learning model and a second machine learning model.

FIG. 9 A schematic diagram for describing analysis results regarding a recognition operation of the first machine learning model.

FIG. 10 A schematic diagram for describing analysis results regarding a recognition operation of the second machine learning model.

FIG. 11 A table for describing a learning method for an integrated machine learning model 26.

FIG. 12 A schematic diagram showing another setting example of annotation classes.

FIG. 13 A graph showing a relationship between an area setting of a dummy class and a loss function value (loss value) of the machine learning model 26.

FIG. 14 A block diagram showing a configuration example of a vehicle control system 100 that controls the vehicle.

FIG. 15 A block diagram showing a hardware configuration example of an information processing apparatus.

### MODE(S) FOR CARRYING OUT THE INVENTION

Hereinafter, embodiments according to the present technology will be described with reference to the drawings.

[Object Recognition System]

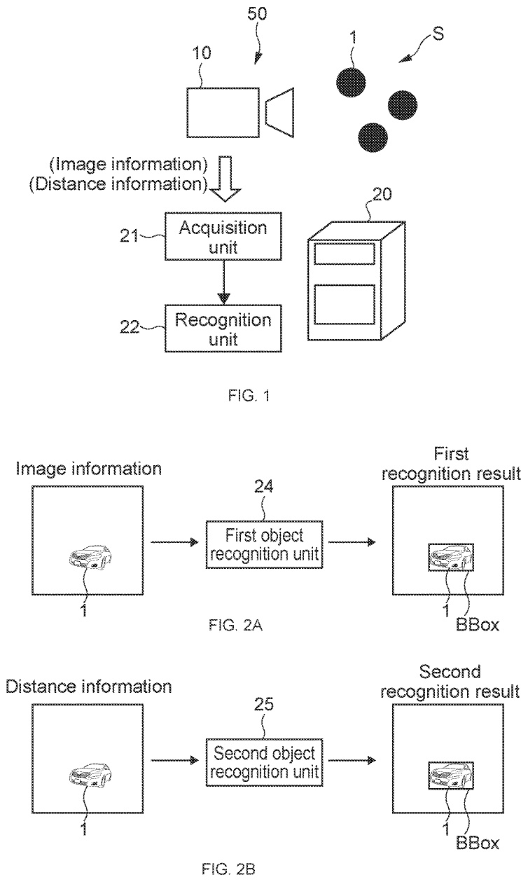

FIG. 1 is a schematic diagram for describing a configuration example of an object recognition system according to an embodiment of the present technology.

An object recognition system 50 includes a sensor unit 10 and an information processing apparatus 20.

The sensor unit 10 and the information processing apparatus 20 are connected to communicate with each other via a wire or wirelessly. The connection form between the respective devices is not limited and, for example, wireless LAN communication such as Wi-Fi or near-field communication such as Bluetooth (registered trademark) can be utilized.

The sensor unit 10 performs sensing with respect to a predetermined sensing region S and outputs a sensing result (detection result).

In the present embodiment, the sensor unit 10 includes an image sensor and a ranging sensor (depth sensor). Therefore, the sensor unit 10 is capable of outputting, as the sensing result, image information and distance information (depth information) with respect to the sensing region S.

For example, the sensor unit 10 detects image information and distance information with respect to the sensing region S at a predetermined frame rate and outputs the image information and the distance information to the information processing apparatus 20.

The frame rate of the sensor unit 10 is not limited, and may be arbitrarily set.

Any image sensor capable of acquiring two-dimensional images may be used as the image sensor. For example, a visible light camera and an infrared camera can be employed. It should be noted that in the present disclosure, the image includes both a still image and a moving image (video).

Any ranging sensor capable of acquiring three-dimensional information may be used as the ranging sensor. For example, a LIDAR device (light detection and ranging device, or laser imaging detection and ranging device), a laser ranging sensor, a stereo camera, a time of flight (ToF) sensor, and a structured light type ranging sensor can be employed.

Alternatively, a sensor having both the functions of the image sensor and the ranging sensor may be used.

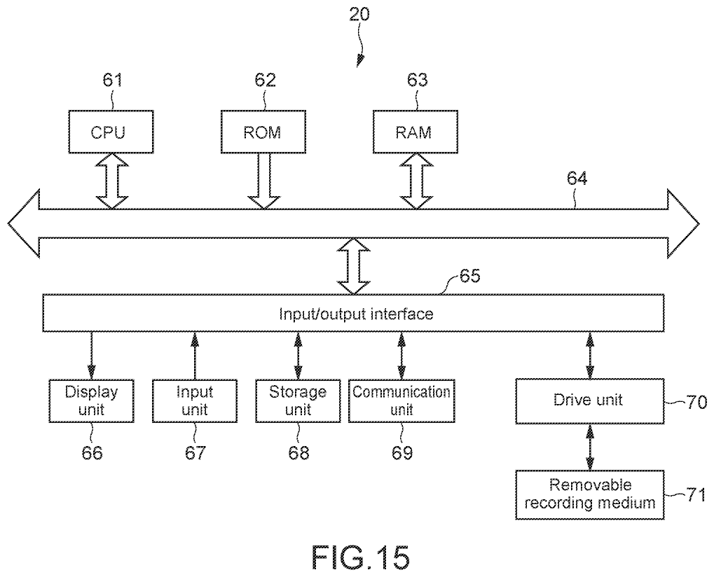

The information processing apparatus 20 includes hardware required for configurations of a computer including, for example, processors such as a CPU, a GPU, and a DSP, memories such as a ROM and a RAM, a storage device such as an HDD (see FIG. 15).

For example, the CPU loads a program according to the present technology recorded in the ROM or the like in advance to the RAM and executes the program to thereby execute an information processing method according to the present technology.

For example, any computer such as a personal computer (PC) can realize the information processing apparatus 20. As a matter of course, hardware such as FPGA and ASIC may be used.

In the present embodiment, when the CPU or the like executes a predetermined program, an acquisition unit 21 and a recognition unit 22 as functional blocks are configured. As a matter of course, dedicated hardware such as an integrated circuit (IC) may be used for realizing functional blocks.

The program is, for example, installed in the information processing apparatus 20 via various recording media. Alternatively, the program may be installed via the Internet or the like.

The kind of recording medium and the like in which the program is recorded are not limited, and any computer-readable recording medium may be used. For example, any computer-readable non-transitory storage medium may be used.

The acquisition unit 21 acquires the image information and the distance information output from the sensor unit 10. That is, the acquisition unit 21 acquires the image information and the distance information with respect to the sensing region S.

The recognition unit 22 performs integration processing by using the image information and the distance information as the input and recognizes a target object 1.

The integration processing is recognition processing in which first recognition processing using the image information as an input and second recognition processing using the distance information as an input are integrated. The integration processing can also be referred to as integration recognition processing.

Typically, the integration processing is performed in synchronization with the output of the image information and the distance information from the sensor unit 10. As a matter of course, the present technology is not limited thereto, and a frame rate different from the frame rate of the sensor unit 10 may be set as a frame rate of the integration processing.

[Integration Processing]

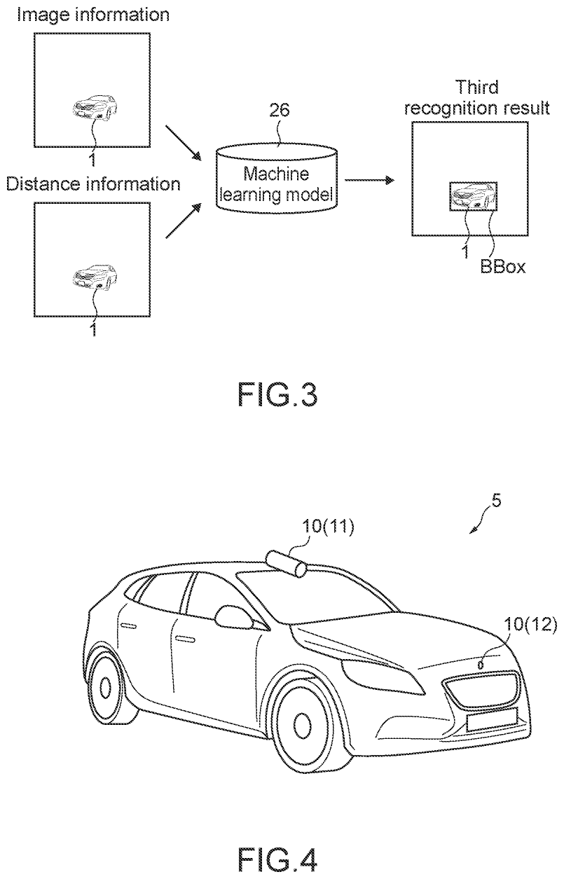

FIGS. 2 and 3 are schematic diagrams for describing a variation example of the integration processing.

In the present disclosure, the integration processing includes various variations to be described below.

It should be noted that in the following descriptions, a case where a vehicle is recognized as the target object 1 will be taken as an example.

(Integration of Recognition Results)

For example, as shown in FIGS. 2A and B, a first object recognition unit 24 that performs first recognition processing and a second object recognition unit 25 that performs second recognition processing are built.

The first object recognition unit 24 performs the first recognition processing and outputs a recognition result (hereinafter, referred to as first recognition result).

Moreover, the second object recognition unit 25 performs the second recognition processing and outputs a recognition result (hereinafter, referred to as second recognition result).

As the integration processing, the first recognition result and the second recognition result are integrated and output as the recognition result of the target object 1.

For example, the first recognition result and the second recognition result are integrated with predetermined weighting. Otherwise, any algorithm for integrating the first recognition result and the second recognition result may be used.

(Selection of Recognition Result)

As the integration processing, the first recognition result or the second recognition result may be selected and output as the recognition result of the target object 1.

It should be noted that the processing of selecting and outputting either one of the first recognition result and the second recognition result can also be realized by setting weighting for one recognition result to 1 and weighting for the other recognition result to 0 in the integration of the recognition results by weighting described above.

It should be noted that as shown in FIG. 2B, in the present embodiment, the distance information (e.g., point cloud data and the like) with respect to the sensing region S is two-dimensionally arranged and used. For example, the second recognition processing may be performed by inputting the distance information to the second object recognition unit 25 as grayscale image information in which distances are associated with shades of gray.

As a matter of course, the handling of the distance information is not limited in the application of the present technology.

The recognition result of the target object 1 includes any information such as a position of the target object 1, a state of the target object 1, and a movement of the target object 1, for example.

In the present embodiment, information related to a region in which the target object 1 in the sensing region S is present is output as the recognition result of the target object 1.

For example, a bounding box (BBox) surrounding the target object 1 is output as the recognition result of the target object 1.

For example, a coordinate system is set with respect to the sensing region S. Based on the coordinate system, positional information of the BBox is calculated.

As the coordinate system, for example, an absolute coordinate system (world coordinate system) is used.

Alternatively, a relative coordinate system using a predetermined point as the basis (point of origin) may be used. In a case where the relative coordinate system is used, the point of origin that is the basis may be arbitrarily set.

As a matter of course, the present technology can also be applied in a case where information different from the BBox is output as the recognition result of the target object 1.

A specific method (algorithm) of the first recognition processing performed by the first object recognition unit 24 using the image information as the input is not limited. For example, any algorithm such as recognition processing using a machine learning-based algorithm and recognition processing using a rule-based algorithm may be used.

For example, any machine learning algorithm using a deep neural network (DNN) or the like may be used as the first recognition processing. The accuracy of the object recognition using the image information as the input can be improved by, for example, using artificial intelligence (AI) or the like that performs deep learning.

For example, a learning unit and an identification unit are built in order to realize machine learning-based recognition processing. The learning unit performs machine learning on the basis of input information (training data) and outputs a learning result. Moreover, the identification unit performs identification of the input information (e.g., judgement, prediction) on the basis of the input information and the learning result.

For example, neural network and deep learning are used for learning techniques in the learning unit. The neural network is a model that mimics neural networks of a human brain. The neural network is constituted by three types of layers of an input layer, an intermediate layer (hidden layer), and an output layer.

The deep learning is a model using neural networks with a multi-layer structure. The deep learning can repeat characteristic learning in each layer and learn complicated patterns hidden in mass data.

The deep learning is, for example, used for the purpose of identifying objects in an image or words in a speech. For example, a convolutional neural network (CNN) or the like used for recognition of an image or moving image is used.

Moreover, a neuro chip/neuromorphic chip in which the concept of the neural network has been incorporated can be used as a hardware structure that realizes such machine learning.

For example, in order to realize machine learning-based first recognition processing, image information for learning and a label are input into the learning unit. The label is also called training label.

The label is information associated with the image information for learning, and for example, the BBox is used. The BBox is set in the image information for learning as the label, to thereby generate training data. It can also be said that the training data is a data set for learning.

Using the training data, the learning unit performs learning on the basis of the machine learning algorithm. With the learning, parameters (coefficients) for calculating the BBox are updated and generated as learned parameters. A program in which the generated learned parameters are incorporated is generated as a learned machine learning model.

The first object recognition unit 24 is built on the basis of the machine learning model, and in response to the input of the image information of the sensing region S, the BBox is output as the recognition result of the target object 1.

Various algorithms, for example, matching processing with a model image, calculation of positional information of the target object 1 using a marker image or the like, and reference to table information can be employed as the recognition processing using the rule-based algorithm.

A specific method (algorithm) of the second recognition processing performed by the second object recognition unit 25 using the distance information as the input is also not limited. For example, any algorithm such as the recognition processing using the machine learning-based algorithm and the recognition processing using the rule-based algorithm described above may be used.

For example, in order to realize machine learning-based second recognition processing, distance information for learning and a label are input into the learning unit.

The label is information associated with the distance information for learning, and for example, the BBox is used. The BBox is set in the distance information for learning as the label, to thereby generate training data.

Using the training data, the learning unit performs learning on the basis of the machine learning algorithm. With the learning, parameters (coefficients) for calculating the BBox are updated and generated as learned parameters. A program in which the generated learned parameters are incorporated is generated as the learned machine learning model.

The second recognition unit 25 is built on the basis of the machine learning model, and in response to the input of the distance information of the sensing region S, the BBox is output as the recognition result of the target object 1.

(Machine Learning-Based Integration Processing)

As shown in FIG. 3, as the integration processing, recognition processing using a machine learning algorithm may be performed using the image information and the distance information as the input.

For example, the BBox associated with the image information for learning as the label, to thereby generate training data. Moreover, the BBox is associated with the distance information for learning as the label, to thereby generate training data.

Using both these kinds of training data, learning is performed on the basis of the machine learning algorithm. With the learning, parameters (coefficients) for calculating the BBox are updated and generated as learned parameters. A program in which the generated learned parameters are incorporated is generated as a learned machine learning model 26.

The recognition unit 22 shown in FIG. 1 is built on the basis of the machine learning model 26, and in response to the input of the image information and the distance information of the sensing region S, the BBox is output as the recognition result of the target object 1.

Thus, the recognition processing based on the machine learning model 26 using the image information and the distance information as the input is also included in the integration processing.

[Integration Processing According to Distance to Target Object 1]

In addition, in the present embodiment, the recognition unit 22 performs integration processing according to the distance to the target object 1 present in the sensing region S.

The integration processing according to the distance to the target object 1 includes any integration processing performed considering information related to the distance to the target object 1 or the distance to the target object 1.

For example, the distance information detected by the sensor unit 10 may be used as the distance to the target object 1. Alternatively, any information correlated to the distance to the target object 1 may be used as the information related to the distance to the target object 1.

For example, a size (e.g., the number of pixels or the like) of a region of the target object 1 included in the image information can be used as the information related to the distance to the target object 1. Moreover, the size of the region of the target object 1 included in the distance information (in a case where grayscale image information is used, the number of pixels, the number of points of a point cloud, or the like) can be used as the information related to the distance to the target object 1.

Otherwise, the distance to the target object 1, which is obtained by another device or the like, may be used. Moreover, any other information may be used as the information regarding the distance to the target object 1.

Hereinafter, the distance to the target object 1 or the information regarding the distance to the target object 1 will be sometimes abbreviated as the “distance to the target object 1 and the like”.

For example, in the integration of the recognition results by weighting described above, the weighting is set on the basis of the distance to the target object 1 and the like. That is, with the weighting according to the distance to the target object 1 and the like, the first recognition result of the first recognition processing and the second recognition result of the second recognition processing are integrated. Such integration processing is included in the integration processing according to the distance to the target object 1.

Moreover, in the above-mentioned selection of the recognition result, the first recognition result of the first recognition processing or the second recognition result of the second recognition processing is output on the basis of the distance to the target object and the like. That is, the first recognition result of the first recognition processing or the second recognition result of the second recognition processing is output in accordance with the distance to the target object. Such integration processing is also included in the integration processing according to the distance to the target object 1.

In the machine learning-based integration processing illustrated in FIG. 3, the recognition processing based on the machine learning model 26 learned using the training data including the distance to the target object 1 and the like is performed.

For example, the size (number of pixels) of the region of the target object 1 included in each of the image information and the distance information is the information related to the distance to the target object 1.

The label is set as appropriate in accordance with the size of the target object 1 included in the image information for learning. Moreover, the label is set as appropriate in accordance with the size of the target object 1 included in the distance information for learning. The learning is performed using these kinds of training data, and the machine learning model 26 is generated.

Based on the thus generated machine learning model 26, the machine learning-based recognition processing is performed by using the image information and the distance information as the input. Accordingly, the integration processing according to the distance to the target object 1 can be realized.

[Application Example of Object Recognition System]

A vehicle control system to which the object recognition system 50 according to the present technology is applied will be described.

Here, a case where the vehicle control system is built in a vehicle and an automated driving function capable of automated driving to a destination is realized will be taken as an example.

FIG. 4 is an external view showing a configuration example of a vehicle 5.

An image sensor 11 and a ranging sensor 12 are installed in the vehicle 5 as the sensor unit 10 illustrated in FIG. 1.

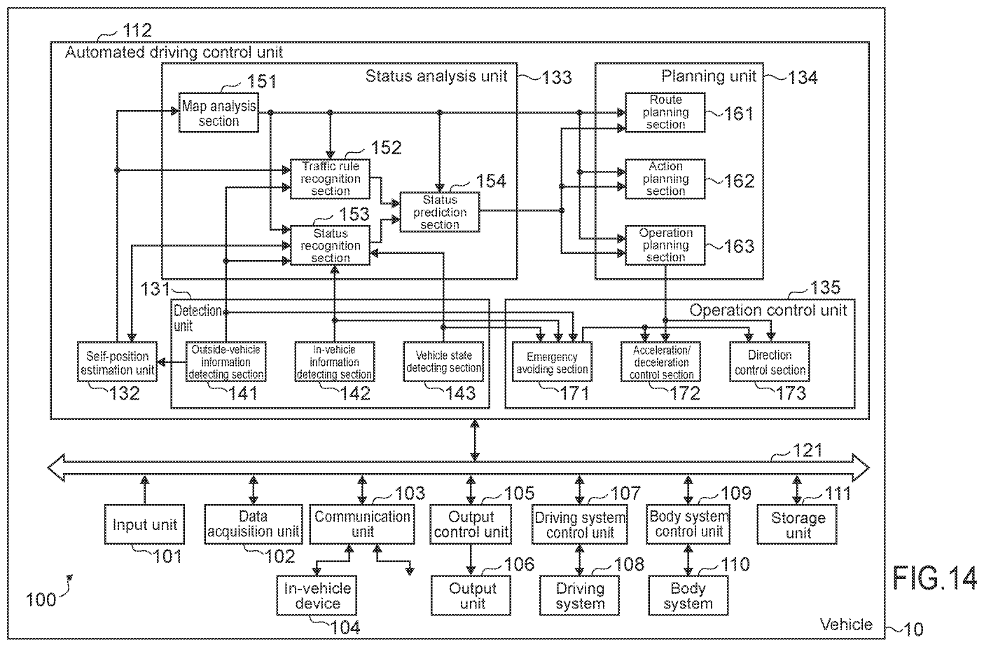

Moreover, a vehicle control system 100 (see FIG. 14) inside the vehicle 5 has the functions of the information processing apparatus 20 illustrated in FIG. 1. That is, the acquisition unit 21 and the recognition unit 22 shown in FIG. 1 are built.

It should be noted that in the recognition unit 22, integration processing using a machine learning algorithm built with the machine learning model 26 shown in FIG. 3 and using the image information and the distance information as the input is performed.

As described above, learning has been performed on the machine learning model 26 to be capable of realizing the integration processing according to the distance to the target object 1.

For example, a computer system on a network performs learning with training data and generates a learned machine learning model 26. Then, the learned machine learning model 26 is sent to the vehicle 5 via the network or the like.

The machine learning model 26 may be provided as a cloud service.

As a matter of course, the present technology is not limited to such a configuration.

Hereinafter, how the machine learning model 26 for performing the integration processing shown in FIG. 3 is learned and designed as a recognizer will be described in detail.

[Computer Simulation]

In the present embodiment, training data is generated by computer simulation. That is, image information and distance information in various kinds of environments (weather, time, topography, the presence/absence of a building, the presence/absence of a vehicle, the presence/absence of an obstacle, the presence/absence of a person, and the like) are generated in CG simulation. Then, BBoxes set as labels to image information and distance information including a vehicle that is the target object 1 (hereinafter, sometimes referred to as vehicle 1 using the same reference sign), to thereby generate training data.

That is, the training data includes the image information and the distance information generated by computer simulation.

The use of the CG simulation makes it possible to arrange any object to be imaged (vehicle 1 or the like) at a desired position in a desired environment (scene) to thereby collect many pieces of training data as if they are actually measured.

Moreover, since the CG enables annotations (BBoxes that are labels) to be automatically added, there is no error caused by manual inputs and precise annotations can be easily collected.

In particular, labels at remote locations can be generated more precisely than manually generated annotations, and precise information related to the distance to the target object 1 can also be added to labels.

Moreover, labels useful for learning can also be collected by repeating an important, often dangerous scenario.

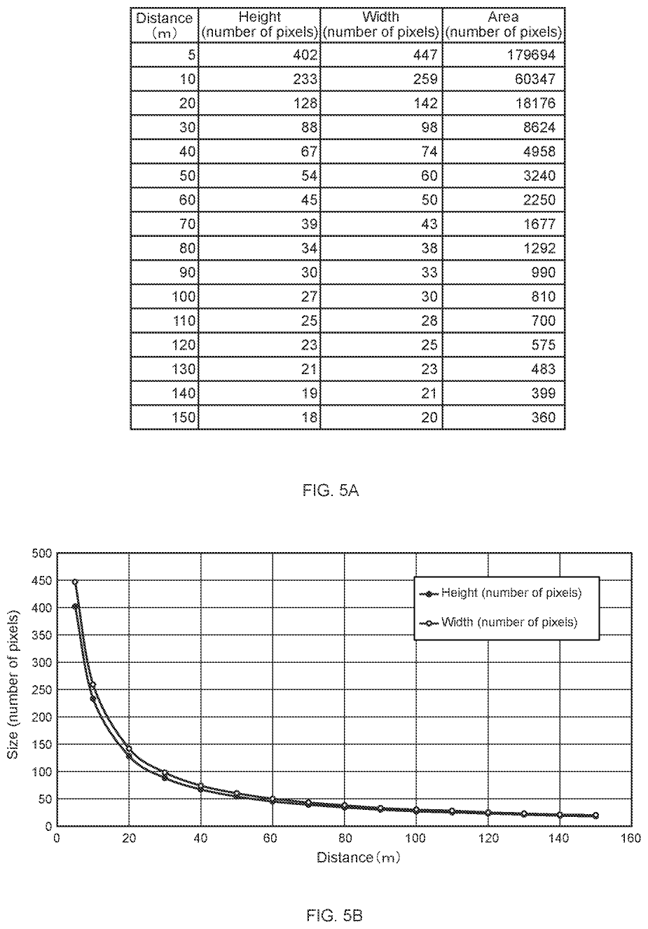

FIG. 5 is table and graph showing an example of a correspondence relationship between the distance to the vehicle 1 present in the sensing region S and the number of pixels of the vehicle 1 in the image information.

The vehicle 1 with 1695 mm (entire width)×1525 mm (entire height) has actually been imaged with a full high vision (FHD) camera with 60 degrees as a field of view (FOV). As shown in FIG. 5, the number of pixels of each of the height and the width was calculated as a size of the vehicle 1 in the captured image.

As shown in FIGS. 5A and B, it can be seen that the distance to the vehicle 1 present in the sensing region S and a size (number of pixels) of a region of the vehicle 1 in the captured image (image information) have a correlation.

Referring to results of from the number of pixels (402×447) in a case where the distance to the target object 1 is 5 m to the number of pixels (18×20) in a case where the distance to the target object is 1150 m, it can be seen that the number of pixels becomes larger as the distance to the target object 1 becomes shorter, and the number of pixels becomes smaller as the distance to the target object 1 becomes longer.

That is, the near vehicle 1 is imaged with a larger size and the remote vehicle 1 is imaged with a smaller size.

Also regarding the distance information detected by the ranging sensor, a similar result is obtained.

As described above, the size (number of pixels) of the vehicle 1 in the image is the information related to the distance to the vehicle 1.

For example, as to image information and distance information detected at the same frame (same timing), the size (number of pixels) of the vehicle 1 in the image as a representative can also be used as information related to the distance to the vehicle 1 with respect to both the image information and the distance information.

That is, as the information related to the distance to the vehicle 1 in the distance information detected at a certain frame, the size (number of pixels) of the vehicle 1 in the image information detected at the same frame may be used.

Here, for the first recognition processing shown in FIG. 2A using the image information as the input, the machine learning-based recognition processing is performed.

That is, learning is performed using training data obtained by setting the label (BBox) in the image information for learning, to thereby build a machine learning model. With the machine learning model, the first object recognition unit 24 shown in FIG. 2A is built.

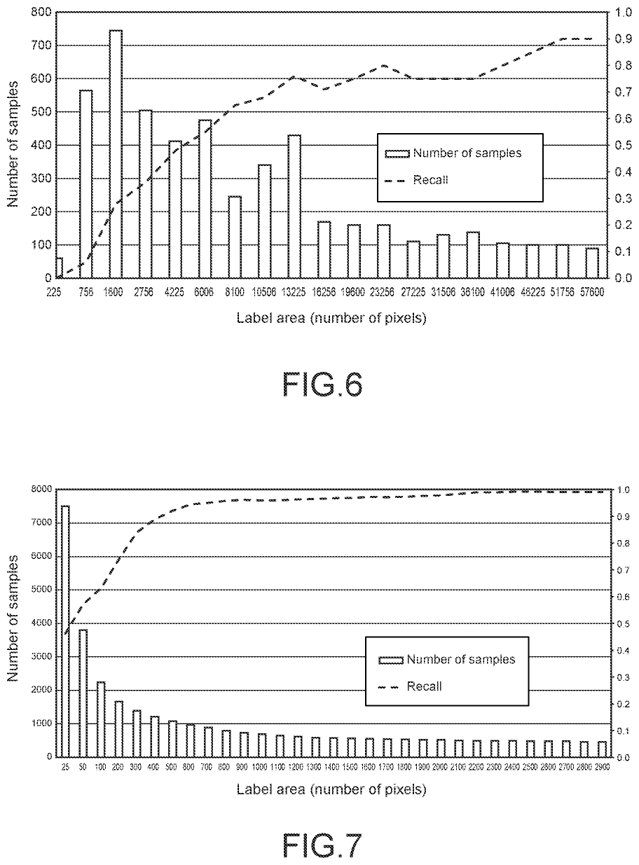

FIG. 6 is a graph showing a distribution of the number of samples and a recall value in a case where training data obtained by setting a label (BBox) manually input in image information obtained by actual measurement was used.

In a case where training data is generated by actual measurement, statuses and the like that can be actually measured are limited. For example, few machines are capable of actually measuring the vehicle 1 located remotely in a natural state, and collecting a sufficient amount of data is very cumbersome, time-consuming work. Moreover, it is also extremely difficult to set a label with respect to the vehicle 1 having a small area (number of pixels).

As shown in FIG. 6, referring to the number of samples of the image information for learning for each area (number of pixels) of the label, the number of samples of the small-area labels is extremely small. Moreover, also regarding a distribution of the number of samples for each area of the label, a non-uniform distribution having a large variance.

Regarding a recall value representing a recognition rate (recall factor) of the machine learning model, the recall value greatly lowers to a remote location from a location where the area is 13225 pixels (in the example shown in FIG. 5, a distance of 20 m to 30 m). Then, the recall value at a location where the area is 224 pixels (in the example shown in FIG. 5, a distance of 150 m or more) is zero.

Thus, in a case where learning is performed using the training data obtained by actual measurement and manual input, it is difficult to realize a high-performance machine learning model. In particular, there is a possibility that the recognition accuracy for the remote vehicle 1 may be extremely low.

FIG. 7 is a graph showing a distribution of the number of samples and a recall value in a case where training data (image information and label) obtained by CG simulation is used.

The use of the CG simulation makes it possible to collect samples of the image information for learning for each area (number of pixels) of the label in a smooth distribution having a small variance. In particular, a scene where a plurality of remote vehicles 1 is arranged, which can be imaged, can also be easily reproduced, and therefore it is easy to acquire a large number of samples with small-area labels.

Moreover, since it is possible to automatically set labels, a precise label can also be set to a vehicle 1 having 100 pixels or less (in the example shown in FIG. 5, a distance of 150 m or more).

Regarding the recall value of the machine learning model, in a pixel range in which the area is larger than 600 pixels (in the example shown in FIG. 5, a distance of 110 m to 120 m), a high recall value close to approximately 1 is realized.

In a range in which the area is smaller than 600 pixels (in the example shown in FIG. 5, a distance of 110 m to 120 m), the recall value lowers but the lowering rate is extremely lower than in the case of the actual measurement shown in FIG. 6. Then, even in a range in which the area is 200 pixels (in the example shown in FIG. 5, a distance of 150 m or more), the recall value is equal to or larger than 0.7.

Thus, in a case where learning is performed using the training data obtained by CG simulation, a high-performance machine learning model can be realized. The recognition accuracy for the remote vehicle 1 is sufficiently maintained also.

For the second recognition processing shown in FIG. 2B using the distance information as the input, the machine learning-based recognition processing is performed.

That is, learning is performed using the training data obtained by setting the label (BBox) in the distance information for learning, to thereby build a machine learning model. The second object recognition unit 25 shown in FIG. 2B is built with the machine learning model.

Also in this case, in a case where learning is performed using the training data obtained by actual measurement and manual input, it is difficult to realize a high-performance machine learning model.

By performing learning with the training data obtained by CG simulation, a high-performance machine learning model can be realized.

Hereinafter, a machine learning model that outputs a recognition result (BBox) using the image information as the input, which is learned using the training data obtained by CG simulation, will be referred to as a first machine learning model.

Moreover, a machine learning model that outputs a recognition result (BBox) using the distance information as the input, which is learned using the training data obtained by CG simulation, will be referred to as a second machine learning model.

Moreover, the machine learning model 26 that outputs a recognition result (BBox) using the image information and the distance information as the input as shown in FIG. 3 will be referred to as an integrated machine learning model 26 using the same reference sign.

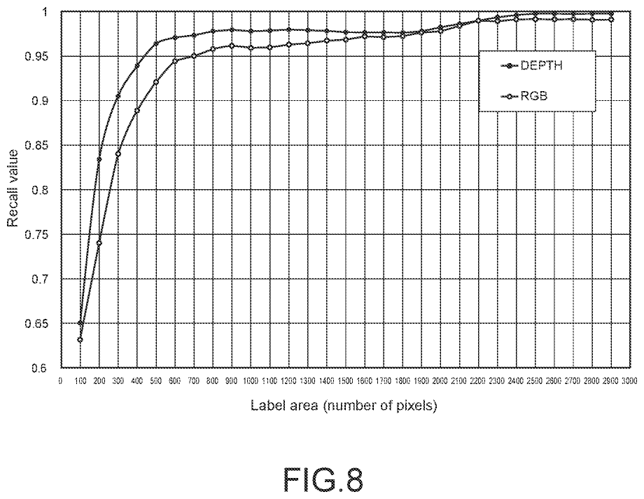

FIG. 8 is a graph showing an example of the recall value of each of the first machine learning model and the second machine learning model.

“RGB” in the figure is RGB image information and is a recall value of the first machine learning model. “DEPTH” is distance information and is a recall value of the second machine learning model.

As shown in FIG. 8, in a range in which the area of the label is larger than 1500 pixels (in the example shown in FIG. 5, a distance of approximately 70 m), for both the first machine learning model and the second machine learning model, the recall values are high values and approximately equal to each other.

In a range in which the area of the label is smaller than 1500 pixels, the recall value of the second machine learning model using the distance information as the input is higher than the recall value of the first machine learning model using the image information as the input.

The inventors repeatedly studied recognition operations with the first machine learning model using the image information as the input and recognition operations with the second machine learning model using the distance information as the input. Specifically, what the prediction was like in a case where a correct BBox was output as a recognition result was analyzed.

Regarding the first machine learning model, a region in the image, which highly contributed to the prediction of the correct BBox, was analyzed using shapley additive explanations (SHAP).

Regarding the second machine learning model, a region in the distance information (grayscale image), which highly contributed to the prediction of the correct BBox, was analyzed using the SHAP.

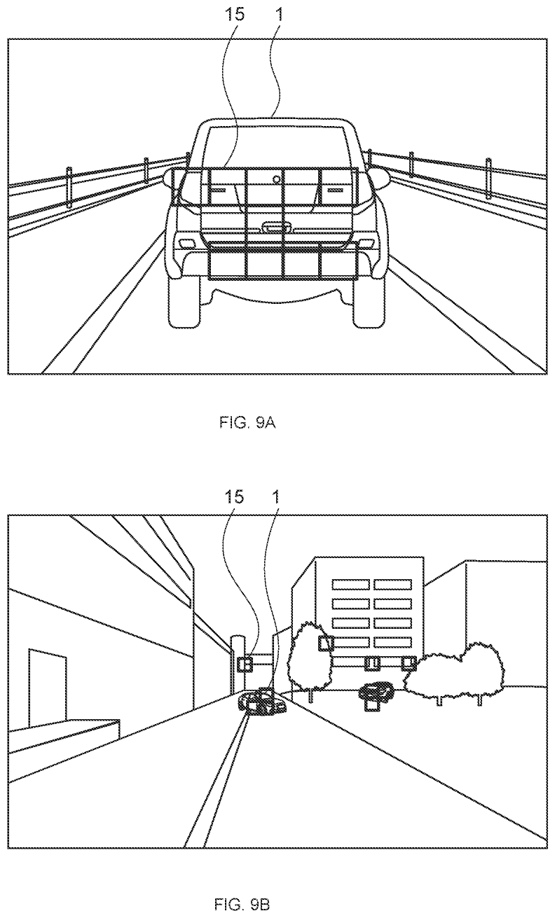

FIG. 9 is a schematic diagram for describing analysis results regarding the recognition operation of the first machine learning model.

In the first recognition processing using the image information as the input, recognition is performed utilizing image features of respective parts of the vehicle 1, such as an A-pillar, a headlamp, a brake lamp, and wheels.

Therefore, it can be said that the first recognition processing shown in FIG. 2A is recognition processing to recognize the target object on the basis of an image feature obtained from the image information.

As shown in FIG. 9A, it can be seen that with respect to the vehicle 1 imaged at a near distance, regions 15 that highly contributed to correct prediction are the respective parts of the vehicle 1. That is, it can be seen that the vehicle 1 is recognized on the basis of the image features of the respective parts of the vehicle 1.

It can be said that the prediction based on the image features of the respective parts of the vehicle 1 is an intended operation as the operation of the first recognition processing using the image information as the input. It can also be said that a correct recognition operation was performed.

As shown in FIG. 9B, it has been found that with respect to the vehicle 1 imaged at a far distance, regions not related to the vehicle 1 were the regions 15 that highly contributed to correct prediction. That is, it has been found that although the vehicle 1 was correctly predicted, the prediction operation was different from an intended operation (correct recognition operation).

For example, due to influences of the lens performance of the image sensor 11, shaking at the time of imaging, weather, and the like, the image features of the vehicle 1 imaged at a far distance are often significantly lost. With respect to the input the image features of which were significantly lost, a state called so-called overtraining (overfitting) occurs and prediction based on the image features of objects (buildings or the like) different from the vehicle 1 can be performed.

In such a case, there is also a high possibility that the recognition can be accidentally correct, and the reliability of the prediction result is low.

As shown in FIGS. 9A and B, in the first recognition processing using the image information as the input, the BBox is correctly output by an intended operation at a distance capable of imaging the image features sufficiently. Thus, a high weather resistance can be provided, and a high generalization ability (ability to adapt to wide-range image information not limited to training data) can be provided.

On the other hand, it has been found that with respect to the vehicle 1 imaged at a far distance, the recognition accuracy lowers (see FIG. 8) and also the recognition operation itself tends to differ from an intended operation. Thus, the weather resistance and generalization ability also lower.

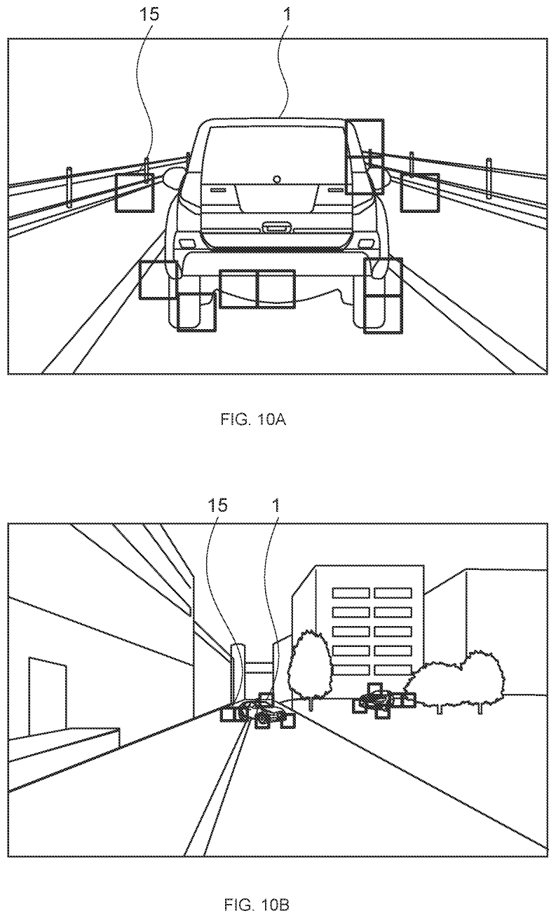

FIG. 10 is a schematic diagram for describing analysis results regarding the recognition operation of the second machine learning model.

In the second recognition processing using the distance information as the input, recognition is performed utilizing characteristic shapes of the respective parts of the vehicle 1, such as front and rear wind screens. Moreover, recognition is performed also utilizing the shapes of the surrounding objects different from the vehicle 1, such as a road and the like.

Therefore, it can be said that the second recognition processing shown in FIG. 2B is recognition processing to recognize the target object on the basis of a shape obtained from the distance information.

As shown in FIG. 10A, with respect to the vehicle 1 sensed at a near distance, it can be seen that the regions 15 that highly contributed to correct prediction are portions forming the outer shape of the vehicle 1, portions of surfaces upright with respect to the road surface, or the like. Moreover, it can be seen that the shapes of the objects surrounding the vehicle 1 also contributed.

Thus, it can be said that the prediction based on the relationship between the shapes of the respective parts of the vehicle 1 and the shapes of the surrounding objects is an intended operation as the operation of the second recognition processing using the distance information as the input. It can also be said that a correct recognition operation is performed.

As shown in FIG. 10B, with respect to the vehicle 1 sensed at a far distance, the vehicle 1 is recognized mainly utilizing a convex shape formed by the vehicle 1 with respect to the road surface. The regions 15 that highly contributed to correct prediction are detected on the periphery of the vehicle 1, centered at a boundary portion between the vehicle 1 and the road surface (portions spaced apart from the vehicle 1 can also be detected).

The recognition utilizing the convex shape of the vehicle 1 can have relatively high recognition accuracy even in a case where the resolution and accuracy of the distance information lower as the distance increases.

It can be said that this recognition utilizing the convex shape of the vehicle 1 is also an intended correct prediction operation as the prediction operation based on the relationship to the shapes of the surrounding objects.

As shown in FIGS. 10A and B, in the second recognition processing using the distance information as the input, the BBox is correctly output by an intended operation at a distance capable of sufficiently sensing the characteristic shapes of the respective parts of the vehicle 1. Thus, high weather resistance can be provided, and high generalization ability can be provided.

Moreover, also with respect to the vehicle 1 sensed at a far distance, the BBox is output with higher recognition accuracy by an intended operation as compared to the first recognition processing (see FIG. 8). Thus, also as for the far distance, high weather resistance and high generalization ability are provided.

As for recognition of the vehicle 1 present at a near distance, the image information often has higher resolution than that of the distance information. Therefore, as for the near distance, the first recognition processing using the image information as the input can be expected to provide higher weather resistance and higher generalization ability.

[Design of Integration Processing]

Based on the above-mentioned study, a design in which the first recognition processing based on the image features is used as a base for the near distance and the second recognition processing based on the shape is used as a base for the far distance has been newly devised for the design of the integration processing illustrated in FIGS. 2 and 3.

That is, in a case where the distance to the target object is relatively short, the target object is recognized by using the first recognition processing as the base. Moreover, in a case where the distance to the target object is relatively long, the target object is recognized by using the second recognition processing as the base. In this manner, the integration processing is designed so that the recognition processing that is the base switches on the basis of the distance.

It should be noted that the “recognition processing that is the base” also includes a case where either the first recognition processing or the second recognition processing is used.

For example, as the integration processing, the integration of the recognition results is performed. In this case, the integration processing is performed by setting weighting for the first recognition result of the first recognition processing to be relatively high in a case where the distance to the target object is relatively short and setting weighting for the second recognition result of the second recognition processing to be relatively high in a case where the distance to the target object is relatively long.

The weighting for the first recognition result is set to be high as the distance to the target object becomes shorter and the weighting for the second recognition result may be set to be high as the distance to the target object becomes longer.

For example, it is assumed that selection of the recognition result is performed as the integration processing. In this case, the recognition result of the first recognition processing is output in a case where the distance to the target object is relatively short and the recognition result of the second recognition processing is output in a case where the distance to the target object is relatively long.

By performing integration of such recognition results and selection of a recognition result, the recognition processing that is the base can be switched on the basis of the distance to the vehicle 1. As criteria for switching, for example, a threshold or the like for the information regarding the distance to the vehicle 1 (the number of pixels of the region of the vehicle 1) can be used. Otherwise, any rule (method) may be employed for switching the recognition processing that is the base in accordance with the distance.

Also in the machine learning-based integration processing shown in FIG. 3, the recognition processing that is the base can be switched on the basis of the distance to the vehicle 1 by learning the integrated machine learning model 26 as appropriate.

Therefore, also as for processing of switching the recognition processing that is the base on the basis of the distance to the vehicle 1, it can be performed on the basis of machine learning such as deep learning. That is, integration of the machine learning-based first recognition processing using the image information as the input with the machine learning-based second recognition processing using the distance information as the input, and the machine learning-based recognition processing using the image information and the distance information as the input including switching the recognition processing that is the base on the basis of the distance to the vehicle 1 can be realized.

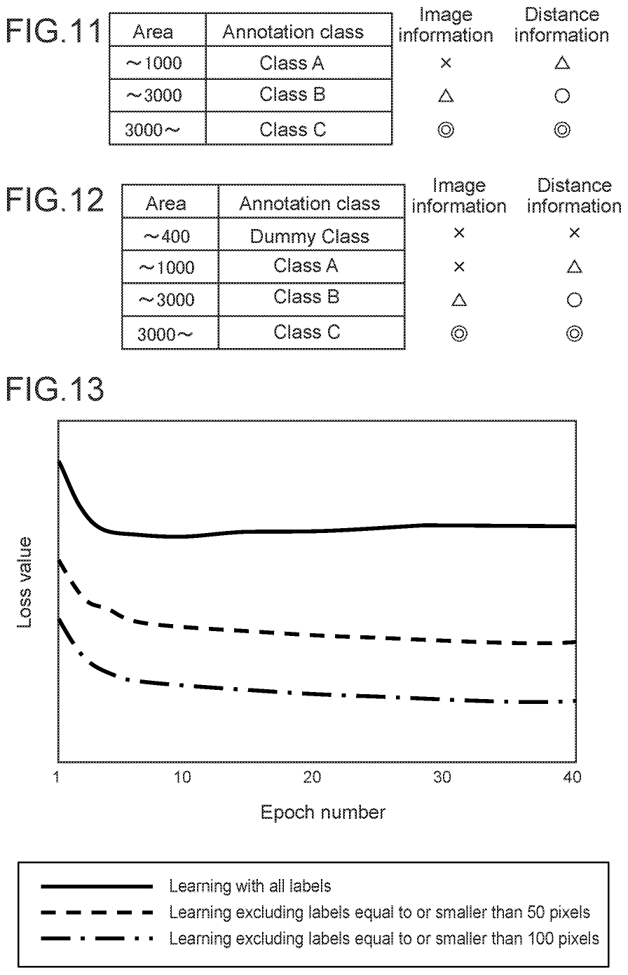

FIG. 11 is a table for describing a learning method of the integrated machine learning model 26.

In the present embodiment, the image information for learning and the distance information for learning that are used as the training data are classified into a plurality of classes (annotation classes) on the basis of the distance to the target object 1. Then, training data is generated by labeling for each of the plurality of classes classified.

For example, as shown in FIG. 11, on the basis of the size (number of pixels) of the region of the vehicle 1 included in the image information for learning and the distance information for learning, classification into three classes A to C is performed.

With respect to the image information for learning and the distance information for learning classified into the class A, the label of the class A is set.

With respect to the image information for learning and the distance information for learning classified into the class B, the label of the class B is set.

With respect to the image information for learning and the distance information for learning classified into the class C, the label of the class C is set.

In FIG. 11, as to each of the image information and the distance information, the recognition accuracy is expressed as the mark “⊚”, “◯”, “Δ”, or “X”. It should be noted that the recognition accuracy set forth herein is a parameter that comprehensively assesses the recognition rate and the correctness of the recognition operation, and is obtained from the analysis result by the SHAP.

In the class A for which the area is smaller than 1000 pixels (in the example shown in FIG. 5, a distance of approximately 90 m), the recognition accuracy of the first recognition processing using the image information as the input is low and the second recognition processing using the distance information as the input has higher recognition accuracy. Thus, the label of the class A is set as appropriate so that the recognition processing based on the second recognition processing is performed.

In the class B for which the area is 1000 pixels to 3000 pixels (in the example shown in FIG. 5, a distance of 50 m to 60 m), the recognition accuracy is enhanced as compared to the class A. Comparing the first recognition processing with the second recognition processing, the recognition accuracy of the second recognition processing is higher. Thus, the label of the class B is set as appropriate so that the recognition processing based on the second recognition processing is performed.

In the class C for which the area is larger than 3000 pixels, high recognition accuracy is provided for both the first recognition processing and the second recognition processing. Thus, for example, the label of the class C is set as appropriate so that the recognition processing based on the first recognition processing is performed.

In this manner, on the basis of the analysis result by the SHAP, the label is set for each annotation class and the integrated machine learning model 26 is learned. Accordingly, the machine learning-based recognition processing using the image information and the distance information as the input including switching the recognition processing that is the base on the basis of the distance to the vehicle 1 can be realized.

It should be noted that with respect to the class C, such a label that the recognition processing based on the second recognition processing is performed may be set.

It is assumed that switching the recognition processing that is the base on the basis of the distance to the vehicle 1 is realized based on rules. In this case, in order to realize highly accurate object recognition, complicated rules considering various kinds of parameters such as lens performance of the image sensor 11, shaking, and weather is often required. Moreover, estimating those parameters by some method in advance is highly likely to be required for applying the rules.

On the other hand, learning is performed by setting the label for each annotation class, and the integrated machine learning model 26 is realized. That is, in a case where switching the recognition processing that is the base on the basis of the distance to the vehicle 1 is also performed based on the machine learning, highly accurate object recognition can be easily realized by sufficiently performing learning.

Moreover, the use of the integrated machine learning model 26 also enables the integrated object recognition based on the distance to the vehicle 1 to be performed with high accuracy using RAW data obtained from the image sensor 11 and the distance sensor 12 as the input. That is, sensor fusion (so-called early fusion) at a stage close to the measurement block of the sensor can also be realized.

Since the RAW data is data containing much information with respect to the sensing region S, high recognition accuracy can be realized.

It should be noted that the number of annotation classes (the number of classes for classification), the area that defines the classification boundaries, and the like are not limited, and may be arbitrarily set.

For example, with respect to each of the first recognition processing using the image information as the input and the second recognition processing using the distance information as the input, classification based on the recognition accuracy (also including the correctness of the recognition operation) is performed. For example, for each of the image and the distance, regions at which each recognition processing is good are classified into classes.

Then, by performing labeling and learning for each region at which each recognition processing is good, a machine learning model having a much larger weight for input information at which each recognition processing is good can be generated.

FIG. 12 is a schematic diagram showing another setting example of the annotation classes.

As shown in FIG. 12, regarding a label for which the area is extremely small, it may be excluded from the training data as a dummy class. At the time of learning the integrated machine learning model 26, the image information and the distance information classified into the dummy class are excluded.

The dummy class is a class classified as a label that cannot be recognized due to its too small size (too far distance) or not required to be recognized. It should be noted that labels classified into the dummy class are not included in negative samples.

In the example shown in FIG. 12, a range in which the area is smaller than 400 pixels (in the example shown in FIG. 5, a distance of approximately 140 m) is set as the dummy class. As a matter of course, the present technology is not limited to such a setting.

FIG. 13 is a graph showing a relationship between an area setting of the dummy class and a loss function value (loss value) of the machine learning model 26. An epoch number on the horizontal axis indicates the number of times of learning.

In the present embodiment, also with respect to an extremely small label, the training data can be precisely generated by the CG simulation.

As shown in FIG. 13, in a case where learning is performed using labels with all sizes, the loss value becomes relatively high. Moreover, the loss value cannot be lowered even by increasing the number of times of learning. In this case, it is difficult to determine whether the learning is proper or not.

For example, in either one of the machine learning-based first recognition processing and the machine learning-based second recognition processing, it can be considered that the overtraining (overfitting) state easily occurs if learning is performed with respect to a label so small that it is extremely difficult to recognize it.

By performing learning excluding unnecessary too small labels, the loss value can be reduced. Moreover, the loss value can also be lowered in accordance with the number of times of learning.

As shown in FIG. 13, in a case where labels equal to or smaller than 50 pixels are classified into the dummy class, the loss value is lowered. In a case where labels equal to or smaller than 100 pixels are classified into the dummy class, the loss value is further lowered.

It should be noted that the recognition accuracy for the vehicle 1 located at a far distance in the second recognition processing based on the distance information is higher than in the first recognition processing based on the image information. Thus, with respect to setting the dummy class, ranges with different sizes may be set for the image information and the distance information. Moreover, it is also possible not to set the dummy class for the distance information but to set the dummy class only for the image information. With such a setting, the accuracy of the machine learning model 26 can be enhanced.

Analysis is performed using the SHAP with respect to the integrated machine learning model 26. As a result, the intended recognition operation as shown in FIG. 9A has been found stably with respect to the vehicle 1 located nearby. The intended recognition operation has been found stably with respect to the vehicle 1 located remotely as shown in FIG. 10B.

That is, the integrated object recognition based on the machine learning model 26 is capable of outputting the BBox at high recognition accuracy by an intended correct recognition operation also in the target object 1 sensed at a far distance and the target object 1 sensed at a near distance. Accordingly, highly accurate object recognition capable of sufficiently describing the recognition operation can be realized.

Hereinabove, in the information processing apparatus 20 according to the present embodiment, the integration processing according to the distance to the target object 1 is performed by using the image information and the distance information of the sensing region S as the input. The integration processing is recognition processing in which the first recognition processing using the image information as the input and the second recognition processing using the distance information as the input are integrated. Accordingly, the recognition accuracy for the target object 1 can be improved.

In the present embodiment, the training data is generated by the CG simulation to thereby build the machine learning model 26. Accordingly, the recognition operation of the machine learning model 26 can be precisely analyzed utilizing the SHAP.

Then, on the basis of the analysis result, the annotation classes are set as illustrated in FIG. 11 and the like, the label is set for each class, and the machine learning model 26 is learned. Accordingly, the integration processing capable of switching the recognition processing that is the base in accordance with the distance to the target object 1 can be easily realized.

The machine learning model 26 has high weather resistance and high generalization ability. Thus, also with respect to the image information and the distance information as actual measurement values, the object recognition can be sufficiently accurately performed.

[Vehicle Control System]

FIG. 14 is a block diagram showing a configuration example of the vehicle control system 100 that controls the vehicle 5. The vehicle control system 100 is a system that is provided in the vehicle 5 and performs various kinds of control on the vehicle 5.

The vehicle control system 100 includes an input unit 101, a data acquisition unit 102, a communication unit 103, an in-vehicle device 104, an output control unit 105, an output unit 106, a driving system control unit 107, a driving system 108, a body system control unit 109, a body system 110, a storage unit 111, and an automated driving control unit 112. The input unit 101, the data acquisition unit 102, the communication unit 103, the output control unit 105, the driving system control unit 107, the body system control unit 109, the storage unit 111, and the automated driving control unit 112 are mutually connected via a communication network 121. The communication network 121 is constituted by, for example, a vehicle-mounted communication network, a bus, and the like compatible with any standards such as a controller area network (CAN), a local interconnect network (LIN), a local area network (LAN), and FlexRay (registered trademark). It should be noted that the respective units of the vehicle control system 100 are directly connected without the communication network 121 in some cases.

It should be noted that hereinafter, in a case where the respective units of the vehicle control system 100 communicate with one another via the communication network 121, the description of the communication network 121 will be omitted. For example, in a case where the input unit 101 and the automated driving control unit 112 communicate with each other via the communication network 121, it will be simply expressed: the input unit 101 and the automated driving control unit 112 communicate with each other.

The input unit 101 includes a device used for an occupant to input various kinds of data, instructions, and the like. For example, the input unit 101 includes an operation device such as a touch panel, a button, a microphone, a switch, and a lever and an operation device and the like capable of inputting using a method other than a manual operation by a voice, a gesture, and the like. Moreover, for example, the input unit 101 may be a remote control device utilizing infrared rays or another radio waves, a mobile device adaptive to operation of the vehicle control system 100, or an external connection device such as a wearable device. The input unit 101 generates an input signal on the basis of data, an instruction, or the like input by the occupant and supplies to the input signal to the respective units of the vehicle control system 100.

The data acquisition unit 102 includes various kinds of sensors and the like that acquire data to be used for processing of the vehicle control system 100, and supplies to the acquired data to the respective units of the vehicle control system 100.

The sensor unit 10 (the image sensor 11 and the ranging sensor 12) illustrated in FIGS. 1 and 4 is included in the data acquisition unit 102.

For example, the data acquisition unit 102 includes various kinds of sensors for detecting a state and the like of the vehicle 5. Specifically, for example, the data acquisition unit 102 includes a gyro sensor, an acceleration sensor, an inertial measurement unit (IMU), a sensor for detecting an amount of operation of an accelerator pedal, an amount of operation of a brake pedal, a steering angle of a steering wheel, engine r.p.m., motor r.p.m., or a rotational speed of the wheels, and the like.

Moreover, for example, the data acquisition unit 102 includes various kinds of sensors for detecting information about the outside of the vehicle 5. Specifically, for example, the data acquisition unit 102 includes an imaging device such as a time-of-flight (ToF) camera, a stereo camera, a monocular camera, an infrared camera, and other cameras. Moreover, for example, the data acquisition unit 102 includes an environmental sensor for detecting atmospheric conditions or weather conditions and a peripheral information detecting sensor for detecting objects on the periphery of the vehicle 5. The environmental sensor is constituted by, for example, a rain drop sensor, a fog sensor, a sunshine sensor, and a snow sensor, and the like. The peripheral information detecting sensor is constituted by, for example, an ultrasonic sensor, a radar device, and a LIDAR device (light detection and ranging device, or laser imaging detection and ranging device), a sound navigation and ranging device (SONAR device), and the like.

In addition, for example, the data acquisition unit 102 includes various kinds of sensors for detecting the current position of the vehicle 5. Specifically, for example, the data acquisition unit 102 includes a GNSS receiver that receives a satellite signal (hereinafter, referred to as GNSS signal) from a global navigation satellite system (GNSS) satellite that is a navigation satellite and the like.

Moreover, for example, the data acquisition unit 102 includes various kinds of sensors for detecting information about the inside of the vehicle. Specifically, for example, the data acquisition unit 102 includes an imaging device that images the driver, a biosensor that detects biological information of the driver, a microphone that collects sound within the interior of the vehicle, and the like. The biosensor is, for example, disposed in a seat surface, the steering wheel, or the like, and detects biological information of an occupant sitting in a seat or the driver holding the steering wheel.

The communication unit 103 communicates with the in-vehicle device 104, and various kinds of outside-vehicle devices, a server, a base station, and the like and sends data supplied from the respective units of the vehicle control system 100 or supplies the received data to the respective units of the vehicle control system 100. It should be noted that a communication protocol supported by the communication unit 103 is not particularly limited, and the communication unit 103 can also support a plurality of kinds of communication protocols.

For example, the communication unit 103 performs wireless communication with the in-vehicle device 104 using wireless LAN, Bluetooth (registered trademark), near field communication (NFC), wireless universal serial bus (WUSB), or the like. In addition, for example, the communication unit 103 performs wired communication with the in-vehicle device 104 by universal serial bus (USB), high-definition multimedia interface (HDMI (registered trademark)), mobile high-definition link (MHL), or the like via a connection terminal (and a cable if necessary) not depicted in the figures.

In addition, for example, the communication unit 103 communicates with a device (for example, an application server or a control server) present on an external network (for example, the Internet, a cloud network, or a company-specific network) via a base station or an access point. Moreover, for example, the communication unit 103 communicates with a terminal present in the vicinity of the vehicle (which terminal is, for example, a terminal of a pedestrian or a store, or a machine type communication (MTC) terminal) using a peer to peer (P2P) technology. In addition, for example, the communication unit 103 carries out V2X communication such as communication between a vehicle and a vehicle (Vehicle to Vehicle), communication between a road and a vehicle (Vehicle to Infrastructure), communication between the vehicle 5 and a home (Vehicle to Home), and communication between a pedestrian and a vehicle (Vehicle to Pedestrian).

Moreover, for example, the communication unit 103 includes a beacon receiving section and receives a radio wave or an electromagnetic wave transmitted from a radio station installed on a road or the like, and thereby obtains information about the current position, congestion, a closed road, a necessary time, or the like.

The in-vehicle device 104 includes, for example, a mobile device and a wearable device possessed by an occupant, an information device carried into or attached to the vehicle 5, a navigation device that searches for a path to an arbitrary destination, and the like.

The output control unit 105 controls the output of various kinds of information to the occupant of the vehicle 5 or the outside of the vehicle. For example, the output control unit 105 generates an output signal including at least one of visual information (e.g., image data) or auditory information (e.g., audio data) and supplies the output signal to the output unit 106, to thereby control the output of the visual information and the auditory information from the output unit 106. Specifically, for example, the output control unit 105 combines image data imaged by different imaging devices of the data acquisition unit 102 to generate a bird's-eye image, a panoramic image, or the like, and supplies an output signal including the generated image to the output unit 106. Moreover, for example, the output control unit 105 generates audio data including an alarm sound, an alarm message, or the like with respect to danger such as collision, contact, and entry in a dangerous zone and supplies to an output signal including the generated audio data to the output unit 106.

The output unit 106 includes a device capable of outputting visual information or auditory information to the occupant of the vehicle 5 or the outside of the vehicle. For example, the output unit 106 includes a display device, an instrument panel, an audio speaker, headphones, a wearable device such as an eyeglass type display worn by an occupant, a projector, a lamp, or the like. The display device provided in the output unit 106 may, for example, be a device that displays visual information in the field of view of the driver such as a head-up display, a see-through display, or a device having an augmented reality (AR) display function other than a device having a normal display.

The driving system control unit 107 generates various kinds of control signals and supplies the various kinds of control signals to the driving system 108, to thereby control the driving system 108. Moreover, the driving system control unit 107 supplies the control signals to the respective units other than the driving system 108 in a manner that depends on needs and performs notification of the control state of the driving system 108 or the like.

The driving system 108 includes various kinds of devices related to the driving system of the vehicle 5. For example, the driving system 108 includes a driving force generating device for generating driving force, such as an internal combustion engine, a driving motor, or the like, a driving force transmitting mechanism for transmitting driving force to the wheels, a steering mechanism for adjusting the steering angle, a braking device for generating braking force, an antilock brake system (ABS), electronic stability control (ESC), an electric power steering device, and the like.

The body system control unit 109 generates various kinds of control signals and supplies the various kinds of control signals to the body system 110, to thereby control the body system 110. Moreover, the body system control unit 109 supplies the control signals to the respective units other than the body system 110 in a manner that depends on needs, and performs notification of the control state of the body system 110 or the like.

The body system 110 includes various kinds of devices provided to the vehicle body. For example, the body system 110 includes a keyless entry system, a smart key system, a power window device, or various kinds of lamps (e.g., a headlamp, a backup lamp, a brake lamp, a turn signal, or a fog lamp), or the like.

The storage unit 111 includes, for example, a read only memory (ROM), a random access memory (RAM), a magnetic storage device such as a hard disc drive (HDD) or the like, a semiconductor storage device, an optical storage device, a magneto-optical storage device, and the like. The storage unit 111 stores various kinds of programs, various kinds of data, and the like used by the respective units of the vehicle control system 100. For example, the storage unit 111 stores map data of a three-dimensional high-precision map such as a dynamic map, a global map that covers a wide area at precision lower than that of a high-precision map, and a local map including information about the surroundings of the vehicle 5, and the like.

The automated driving control unit 112 performs control regarding automated driving such as autonomous driving or driving assistance. Specifically, for example, the automated driving control unit 112 may perform cooperative control intended to implement functions of an advanced driver assistance system (ADAS) including collision avoidance or shock mitigation for the vehicle 5, following driving based on a following distance, vehicle speed maintaining driving, a warning of collision of the vehicle 5, a warning of deviation of the vehicle 5 from a lane, and the like. Moreover, for example, the automated driving control unit 112 performs cooperative control intended for automated driving, which makes the vehicle to travel automatedly without depending on the operation of the driver, or the like. The automated driving control unit 112 includes a detection unit 131, a self-position estimation unit 132, a status analysis unit 133, a planning unit 134, and an operation control unit 135.

The automated driving control unit 112 includes, for example, hardware required for a computer, such as a CPU, a RAM, and a ROM. The CPU loads a program recorded on the ROM in advance to the RAM and execute the program, and various kinds of information processing methods are thus performed.

The automated driving control unit 112 realizes the functions of the information processing apparatus 20 shown in FIG. 1.

A specific configuration of the automated driving control unit 112 is not limited and, for example, a programmable logic device (PLD) such as a field programmable gate array (FPGA) or another device such as an application specific integrated circuit (ASIC) may be used.

As shown in FIG. 14, the automated driving control unit 112 includes the detection unit 131, the self-position estimation unit 132, the status analysis unit 133, the planning unit 134, and the operation control unit 135. For example, the CPU of the automated driving control unit 112 executes the predetermined program to thereby configure the respective functional blocks.

The detection unit 131 detects various kinds of information required for controlling automated driving. The detection unit 131 includes an outside-vehicle information detecting section 141, an in-vehicle information detecting section 142, and a vehicle state detecting section 143.

The outside-vehicle information detecting section 141 performs detection processing of information about the outside of the vehicle 5 on the basis of data or signals from the respective units of the vehicle control system 100. For example, the outside-vehicle information detecting section 141 performs detection processing of an object on the periphery of the vehicle 5, recognition processing, and tracking processing, and detection processing of a distance to an object. An object that is a detection target includes, for example, a vehicle, a human, an obstacle, a structure, a road, a traffic light, a traffic sign, a road sign, and the like. Moreover, for example, the outside-vehicle information detecting section 141 performs detection processing of an environment surrounding the vehicle 5. The surrounding environment that is the detection target includes, for example, weather, temperature, humidity, brightness, and a condition on a road surface, and the like. The outside-vehicle information detecting section 141 supplies data indicating a result of the detection processing to the self-position estimation unit 132, a map analysis section 151, a traffic rule recognition section 152, and a status recognition section 153 of the status analysis unit 133, an emergency avoiding section 171 of the operation control unit 135, and the like.

For example, the acquisition unit 21 and the recognition unit 22 shown in FIG. 1 are built in the outside-vehicle information detecting section 141. Then, the integration processing according to the distance to the target object 1, which has been described above, is performed.

The in-vehicle information detecting section 142 performs detection processing of information about the inside of the vehicle on the basis of data or signals from the respective units of the vehicle control system 100. For example, the in-vehicle information detecting section 142 performs authentication processing and recognition processing of the driver, detection processing of the state of the driver, detection processing of the occupant, and detection processing of an environment inside the vehicle, and the like. The state of the driver that is the detection target includes, for example, a physical condition, vigilance, a degree of concentration, a degree of fatigue, a gaze direction, and the like. The environment inside the vehicle that is the detection target includes, for example, temperature, humidity, brightness, odor, and the like. The in-vehicle information detecting section 142 supplies data indicating a result of the detection processing to the status recognition section 153 of the status analysis unit 133, the emergency avoiding section 171 of the operation control unit 135, and the like.

The vehicle state detecting section 143 performs detection processing of the state of the vehicle 5 on the basis of data or signals from the respective units of the vehicle control system 100. The state of the vehicle 5 that is the detection target includes, for example, a speed, acceleration, a steering angle, the presence/absence and contents of an abnormality, a state of a driving operation, position and tilt of the power seat, a door lock state, a state of another vehicle-mounted device, and the like. The vehicle state detecting section 143 supplies data indicating a result of the detection processing to the status recognition section 153 of the status analysis unit 133, the emergency avoiding section 171 of the operation control unit 135, and the like.

Based on data or signals from the respective units of the vehicle control system 100, such as the outside-vehicle information detecting section 141 and the status recognition section 153 of the status analysis unit 133, the self-position estimation unit 132 performs estimation processing of the position and the attitude and the like of the vehicle 5. Moreover, the self-position estimation unit 132 generates a local map (hereinafter, referred to as map for self-position estimation) used for estimating the self-position in a manner that depends on needs. The map for self-position estimation is, for example, a high-precision map using a technology such as simultaneous localization and mapping (SLAM). The self-position estimation unit 132 supplies data indicating a result of the estimation processing to the map analysis section 151, the traffic rule recognition section 152, and the status recognition section 153 of the status analysis unit 133, and the like. Moreover, the self-position estimation unit 132 causes the storage unit 111 to store the map for self-position estimation.

Hereinafter, the estimation processing of the position and the attitude and the like of the vehicle 5 will be sometimes referred to as self-position estimation processing. Moreover, the information about the position and the attitude of the vehicle 5 will be referred to as position and attitude information. Therefore, the self-position estimation processing performed by the self-position estimation unit 132 is processing of estimating the position and attitude information of the vehicle 5.

The status analysis unit 133 performs analysis processing of the vehicle 5 and the surrounding status. The status analysis unit 133 includes the map analysis section 151, the traffic rule recognition section 152, the status recognition section 153, and a status prediction section 154.

The map analysis section 151 performs analysis processing of various kinds of maps stored in the storage unit 111 and builds a map including information required for processing of automated driving while using data or signals from the respective units of the vehicle control system 100, such as the self-position estimation unit 132 and the outside-vehicle information detecting section 141, in a manner that depends on needs. The map analysis section 151 supplies the built map to the traffic rule recognition section 152, the status recognition section 153, the status prediction section 154, a route planning section 161, an action planning section 162, and an operation planning section 163 of the planning unit 134, and the like.

Based on data or signals from the respective units of the vehicle control system 100, such as the self-position estimation unit 132, the outside-vehicle information detecting section 141, and the map analysis section 151, the traffic rule recognition section 152 performs recognition processing of the traffic rules on the periphery of the vehicle 5. With this recognition processing, for example, positions and states of signals on the periphery of the vehicle 5, the contents of traffic regulation of the periphery of the vehicle 5, and a lane where driving is possible, and the like are recognized. The traffic rule recognition section 152 supplies data indicating a result of the recognition processing to the status prediction section 154 and the like.

Based on data or signals from the respective units of the vehicle control system 100, such as the self-position estimation unit 132, the outside-vehicle information detecting section 141, the in-vehicle information detecting section 142, the vehicle state detecting section 143, and the map analysis section 151, the status recognition section 153 performs recognition processing of a status regarding the vehicle 5. For example, the status recognition section 153 performs recognition processing of the status of the vehicle 5, the status of the periphery of the vehicle 5, and the status of the driver of the vehicle 5, and the like. Moreover, the status recognition section 153 generates a local map (hereinafter, referred to as map for status recognition) used for recognition of the status of the periphery of the vehicle 5 in a manner that depends on needs. The map for status recognition is, for example, a occupancy grid map.

The status of the vehicle 5 that is the recognition target includes, for example, the position, attitude, and movement (e.g., the speed, acceleration, the movement direction, and the like) of the vehicle 5, and the presence/absence and the contents of an abnormality, and the like. The status of the periphery of the vehicle 5 that is the recognition target includes, for example, the kind and the position of surrounding stationary object, kinds, positions and movements of surrounding moving objects (e.g., the speed, acceleration, the movement direction, and the like), a configuration of a surrounding road and a state of the road surface, and the weather, the temperature, the humidity, and brightness of the periphery, and the like. The state of the driver that is the recognition target includes, for example, a physical condition, vigilance, a degree of concentration, a degree of fatigue, movement of the line of sight, and a driving operation, and the like.

The status recognition section 153 supplies data indicating a result of the recognition processing (including the map for status recognition as necessary) to the self-position estimation unit 132, the status prediction section 154, and the like. Moreover, the status recognition section 153 causes the storage unit 111 to store the map for status recognition.

Based on data or signals from the respective units of the vehicle control system 100, such as the map analysis section 151, the traffic rule recognition section 152, and the status recognition section 153, the status prediction section 154 performs prediction processing of a status regarding the vehicle 5. For example, the status prediction section 154 performs prediction processing of the status of the vehicle 5, the status of the periphery of the vehicle 5, and the status of the driver, and the like.

The status of the vehicle 5 that is a prediction target includes, for example, behaviors of the vehicle 5, the occurrence of an abnormality, and a distance to empty, and the like. The status of the periphery of the vehicle 5 that is the prediction target includes, for example, behaviors of a moving object on the periphery of the vehicle 5, a change in a state of a signal, and a change in an environment such as weather, and the like. The status of the driver that is the prediction target includes, for example, behaviors and a physical condition of the driver and the like.

The status prediction section 154 supplies data indicating a result of the prediction processing to the route planning section 161, the action planning section 162, and the operation planning section 163 of the planning unit 134, and the like together with data from the traffic rule recognition section 152 and the status recognition section 153.

Based on data or signals from the respective units of the vehicle control system 100, such as the map analysis section 151 and the status prediction section 154, the route planning section 161 plans a route to a destination. For example, on the basis of a global map, the route planning section 161 sets a target path that is a route from the current position to a specified destination. Moreover, for example, the route planning section 161 changes the route as appropriate on the basis of a status such as congestion, an accident, traffic regulation, and construction work, and a physical condition of the driver, or the like. The route planning section 161 supplies data indicating the planned route to the action planning section 162 and the like.

Based on data or signals from the respective units of the vehicle control system 100, such as the map analysis section 151 and the status prediction section 154, the action planning section 162 plans an action of the vehicle 5 for safely driving on a route planned by the route planning section 161 in a planned time. For example, the action planning section 162 performs planning start, stop, a driving direction (e.g., going forward, going rearward, a left turn, a right turn, a direction change, or the like), a driving lane, a driving speed, and overtaking, and the like. The action planning section 162 supplies data indicating the planned action of the vehicle 5 to the operation planning section 163 and the like.

Based on data or signals from the respective units of the vehicle control system 100, such as the map analysis section 151 and the status prediction section 154, the operation planning section 163 plans an operation of the vehicle 5 for realizing the action planned by the action planning section 162. For example, the operation planning section 163 plans acceleration, deceleration, a driving trajectory, and the like. The operation planning section 163 supplies data indicating the planned operation of the vehicle 5 to the acceleration/deceleration control section 172 and the direction control section 173 of the operation control unit 135 and the like.

The operation control unit 135 controls the operation of the vehicle 5. The operation control unit 135 includes the emergency avoiding section 171, an acceleration/deceleration control section 172, and a direction control section 173.

Based on detection results of the outside-vehicle information detecting section 141, the in-vehicle information detecting section 142, and the vehicle state detecting section 143, the emergency avoiding section 171 performs detection processing of an emergency such as collision, contact, entry in a dangerous zone, an abnormality of the driver, and an abnormality of the vehicle 5. In a case where the emergency avoiding section 171 has detected the occurrence of the emergency, the emergency avoiding section 171 plans an operation of the vehicle 5 for avoiding an emergency such as sudden stop and sudden turn. The emergency avoiding section 171 supplies data indicating the planned operation of the vehicle 5 to the acceleration/deceleration control section 172, and the direction control section 173, and the like.

The acceleration/deceleration control section 172 performs acceleration/deceleration control for realizing the operation of the vehicle 5, which has been planned by the operation planning section 163 or the emergency avoiding section 171. For example, the acceleration/deceleration control section 172 calculates a control target value for the driving force generating device or the braking device for realizing the planned acceleration, deceleration, or sudden stop and supplies a control command indicating the calculated control target value to the driving system control unit 107.

The direction control section 173 performs direction control for realizing the operation of the vehicle 5, which has been planned by the operation planning section 163 or the emergency avoiding section 171. For example, the direction control section 173 calculates a control target value for a steering mechanism for realizing a driving trajectory or sudden turn planned by the operation planning section 163 or the emergency avoiding section 171 and supplies a control command indicating the calculated control target value to the driving system control unit 107.

### Other Embodiments

The present technology is not limited to the above-mentioned embodiments, and various other embodiments can be realized.

The application of the present technology is not limited to learning with the training data generated by CG simulation. For example, a machine learning model for performing the integration processing may be generated using the training data obtained by actual measurement and manual input.

FIG. 15 is a block diagram showing a hardware configuration example of the information processing apparatus 20.

The information processing apparatus 20 includes a CPU 61, a ROM (read only memory) 62, a RAM 63, an input/output interface 65, and a bus 64 that connects them to one another. A display unit 66, an input unit 67, a storage unit 68, a communication unit 69, and a drive unit 70, and the like are connected to the input/output interface 65.

The display unit 66 is, for example, a display device using liquid-crystal, EL, or the like. The input unit 67 is, for example, a keyboard, a pointing device, a touch panel, or another operation device. In a case where the input unit 67 includes a touch panel, the touch panel can be integral with the display unit 66.

The storage unit 68 is a nonvolatile storage device and is, for example, an HDD, a flash memory, or another solid-state memory. The drive unit 70 is, for example, a device capable of driving a removable recording medium 71 such as an optical recording medium and a magnetic record tape.

The communication unit 69 is a modem, a router, or another communication device for communicating with the other devices, which are connectable to a LAN, WAN or the like. The communication unit 69 may perform wired communication or may perform wireless communication. The communication unit 69 is often used separately from the information processing apparatus 20.

The information processing by the information processing apparatus 20 having the hardware configuration as described above is realized by cooperation of software stored in the storage unit 68, the ROM 62, or the like with hardware resources of the information processing apparatus 20. Specifically, by loading the program that configures the software to the RAM 63, which has been stored in the ROM 62 or the like, and executing the program, the information processing method according to the present technology is realized.

The program is, for example, installed in the information processing apparatus 20 via the recording medium 61. Alternatively, the program may be installed in the information processing apparatus 20 via a global network or the like. Otherwise, any computer-readable non-transitory storage medium may be used.

An information processing apparatus according to the present technology may be configured integrally with another device such as a sensor and a display device. That is, the functions of the information processing apparatus according to the present technology may be installed in the sensor, the display device, or the like. In this case, the sensor or the display device itself is an embodiment of the information processing apparatus according to the present technology.

The application of the object recognition system 50 illustrated in FIG. 1 is not limited to the application to the vehicle control system 100 illustrated in FIG. 14. The object recognition system according to the present technology can be applied to any system in any field that needs to recognize the target object.

By cooperation of a plurality of computers mounted connected to communicate with one another via a network or the like, the information processing method and the program according to the present technology may be executed and the information processing apparatus according to the present technology may be configured.

That is, the information processing method and the program according to the present technology can be executed not only in a computer system configured by a single computer but also in a computer system in which a plurality of computer operates in cooperation. It should be noted that in the present disclosure, the system means a group of a plurality of components (apparatuses, modules (components), and the like) and it does not matter whether or not all components is in the same casing. Therefore, a plurality of apparatuses housed in separate casings and connected via a network and a single apparatus in which a plurality of modules is housed in a single casing are both systems.

The execution of the information processing method and the program according to the present technology according to the present technology by the computer system includes, for example, both a case where the acquisition of the image information and the distance information, the integration processing, and the like are performed by a single computer and a case where the respective processes are performed by different computers. Moreover, execution of the respective processes by a predetermined computer includes causing another computer to performing some or all of the processes to acquire the results.

That is, the information processing method and the program according to the present technology can also be applied to a cloud computing configuration in which a single function is shared and cooperatively processed by a plurality of apparatuses via a network.

The respective configurations such as the object recognition system, the vehicle control system, the sensor, and the information processing apparatus, the respective flows of the first recognition processing, the second recognition processing, the integration processing, and the like, which have been described with reference to the respective drawings, are merely embodiments, and can be arbitrarily modified without departing from the gist of the present technology. That is, any other configuration, algorithm, and the like for carrying out the present technology may be employed.

In the present disclosure, an expression with “than”, e.g., “larger than A” or “smaller than A”, is an expression comprehensively including both of a concept including a case where it is equivalent to A and a concept not including a case where it is equivalent to A. For example, “larger than A” is not limited to a case where it is equivalent to A, and also includes “equal to or larger than A”. Moreover, “smaller than A” is not limited to “smaller than A”, and also includes “equal to or smaller than A”.

When carrying out the present technology, it is sufficient to employ specific settings and the like as appropriate from the concepts included in “larger than A” and “smaller than A” so as to provide the above-mentioned effects.

In the present disclosure, it is assumed that the concepts that define the shape, the size, the position relationship, the state, and the like such as “center”, “middle”, “uniform”, “equal”, the “same”, “orthogonal”, “parallel”, “symmetric”, “extending”, “axial”, “columnar”, “cylindrical”, “ring-shaped”, and “annular” are concepts including “substantially center”, “substantially middle”, “substantially uniform”, “substantially equal”, “substantially the same”, “substantially orthogonal”, “substantially parallel”, “substantially symmetric”, “substantially extending”, “substantially axial”, “substantially columnar”, “substantially cylindrical”, “substantially ring-shaped”, “substantially annular”, and the like.

For example, states included in a predetermined range (e.g., ±10% range) using “completely center”, “completely middle”, “completely uniform”, “completely equal”, “completely the same”, “completely orthogonal”, “completely parallel”, “completely symmetric”, “completely extending”, “completely axial”, “completely columnar”, “completely cylindrical”, “completely ring-shaped”, “completely annular”, and the like as the basis are also included.

Therefore, also in a case where the term “approximately” is not added, they can include concepts expressed by adding so-called “approximately”. In contrast, states expressed with “approximately” should not be understood to exclude complete states.

At least two feature parts of the feature parts of the present technology described above can also be combined. That is, various feature parts described in each of the above-mentioned embodiments may be arbitrarily combined across those embodiments. Moreover, various effects described above are merely exemplary and not limitative and also other effects may be provided.

It should be noted that the present technology can also take the following configurations.

(1) An information processing apparatus, including:

an acquisition unit acquires image information and distance information with respect to a sensing region; and

a recognition unit that performs integration processing according to a distance to a target object present in the sensing region and recognizes the target object by using the image information and the distance information as an input, in which

the integration processing is recognition processing in which first recognition processing using the image information as an input and second recognition processing using the distance information as an input are integrated.

(2) The information processing apparatus according to (1), in which

the recognition unit recognizes the target object by using the first recognition processing as a base in a case where the distance to the target object is relatively short.

(3) The information processing apparatus according to (1) or (2), in which

the recognition unit recognizes the target object by using the second recognition processing as a base in a case where the distance to the target object is relatively long.

(4) The information processing apparatus according to any one of (1) to (3), in which

each of the first recognition processing and the second recognition processing is recognition processing using a machine learning algorithm.

(5) The information processing apparatus according to any one of (1) to (4), in which

the first recognition processing is recognition processing to recognize the target object on the basis of an image feature obtained from the image information, and

the second recognition processing is processing to recognize the target object on the basis of a shape obtained from the distance information.

(6) The information processing apparatus according to any one of (1) to (5), in which

the integration processing according to the distance to the target object is recognition processing using a machine learning algorithm.

(7) The information processing apparatus according to (6), in which

the integration processing according to the distance to the target object is recognition processing based on a machine learning model learned from training data including information related to the distance to the target object.

(8) The information processing apparatus according to (7), in which

the information related to the distance to the target object is a size of a region of the target object included in each of the image information and the distance information.

(9) The information processing apparatus according to (7) or (8), in which

the training data is generated in such a manner that the image information and the distance information are classified into a plurality of classes and labelling is performed for each of the plurality of classes classified.

(10) The information processing apparatus according to any one of (7) to (9), in which

the classification of the plurality of classes is classification based on a size of a region of the target object included in each of the image information and the distance information.

(11) The information processing apparatus according to any one of (7) to (10), in which

the training data includes the image information and the distance information generated by computer simulation.

(12) The information processing apparatus according to any one of (1) to (6), in which

the integration processing is processing to integrate, with weighting according to a distance to the target object, a recognition result of the first recognition processing using the image information as the input and a recognition result of the second recognition processing using the distance information as the input.

(13) The information processing apparatus according to (12), in which

the recognition unit sets the weighting of the recognition result of the first recognition processing to be relatively high in a case where the distance to the target object is relatively short, sets the weighting of the recognition result of the second recognition processing to be relatively high in a case where the distance to the target object is relatively long, and performs the integration processing.

(14) The information processing apparatus according to any one of (1) to (6), in which

the integration processing is processing to output, in accordance with a distance to the target object, a recognition result of the first recognition processing using the image information as the input or a recognition result of the second recognition processing using the distance information as the input.

(15) The information processing apparatus according to (14), in which

the recognition unit outputs the recognition result of the first recognition processing in a case where the distance to the target object is relatively short and outputs the recognition result of the second recognition processing in a case where the distance to the target object is relatively long.

(16) The information processing apparatus according to any one of (1) to (15), in which

the recognition unit outputs information related to a region in which the target object in the sensing region is present, as the recognition result.

(17) An information processing method to be executed by a computer system, including:

a step of acquiring image information and distance information with respect to a sensing region; and

a step of performing integration processing according to a distance to a target object present in the sensing region and recognizing the target object by using the image information and the distance information as an input, in which

the integration processing is recognition processing in which first recognition processing using the image information as an input and second recognition processing using the distance information as an input are integrated.

(18) A program that causes a computer system to execute an information processing method including:

a step of acquiring image information and distance information with respect to a sensing region; and

a step of performing integration processing according to a distance to a target object present in the sensing region and recognizing the target object by using the image information and the distance information as an input, in which

the integration processing is recognition processing in which first recognition processing using the image information as an input and second recognition processing using the distance information as an input are integrated.

### REFERENCE SIGNS LIST

1 target object (vehicle)
5 vehicle
10 sensor unit
20 information processing apparatus
21 acquisition unit
22 recognition unit
26 integrated machine learning model
50 object recognition system
100 vehicle control system

1. An information processing apparatus, comprising:
an acquisition unit acquires image information and distance information with respect to a sensing region; and
a recognition unit that performs integration processing according to a distance to a target object present in the sensing region and recognizes the target object by using the image information and the distance information as an input, wherein
the integration processing is recognition processing in which first recognition processing using the image information as an input and second recognition processing using the distance information as an input are integrated.

2. The information processing apparatus according to claim 1, wherein
the recognition unit recognizes the target object by using the first recognition processing as a base in a case where the distance to the target object is relatively short.

3. The information processing apparatus according to claim 1, wherein
the recognition unit recognizes the target object by using the second recognition processing as a base in a case where the distance to the target object is relatively long.

4. The information processing apparatus according to claim 1, wherein
each of the first recognition processing and the second recognition processing is recognition processing using a machine learning algorithm.

5. The information processing apparatus according to claim 1, wherein
the first recognition processing is recognition processing to recognize the target object on a basis of an image feature obtained from the image information, and
the second recognition processing is processing to recognize the target object on a basis of a shape obtained from the distance information.

6. The information processing apparatus according to claim 1, wherein
the integration processing according to the distance to the target object is recognition processing using a machine learning algorithm.

7. The information processing apparatus according to claim 6, wherein
the integration processing according to the distance to the target object is recognition processing based on a machine learning model learned from training data including information related to the distance to the target object.

8. The information processing apparatus according to claim 7, wherein
the information related to the distance to the target object is a size of a region of the target object included in each of the image information and the distance information.

9. The information processing apparatus according to claim 7, wherein
the training data is generated in such a manner that the image information and the distance information are classified into a plurality of classes and labelling is performed for each of the plurality of classes classified.

10. The information processing apparatus according to claim 7, wherein
the classification of the plurality of classes is classification based on a size of a region of the target object included in each of the image information and the distance information.

11. The information processing apparatus according to claim 7, wherein
the training data includes the image information and the distance information generated by computer simulation.

12. The information processing apparatus according to claim 1, wherein
the integration processing is processing to integrate, with weighting according to a distance to the target object, a recognition result of the first recognition processing using the image information as the input and a recognition result of the second recognition processing using the distance information as the input.

13. The information processing apparatus according to claim 12, wherein
the recognition unit sets the weighting of the recognition result of the first recognition processing to be relatively high in a case where the distance to the target object is relatively short, sets the weighting of the recognition result of the second recognition processing to be relatively high in a case where the distance to the target object is relatively long, and performs the integration processing.

14. The information processing apparatus according to claim 1, wherein
the integration processing is processing to output, in accordance with a distance to the target object, a recognition result of the first recognition processing using the image information as the input or a recognition result of the second recognition processing using the distance information as the input.

15. The information processing apparatus according to claim 14, wherein
the recognition unit outputs the recognition result of the first recognition processing in a case where the distance to the target object is relatively short and outputs the recognition result of the second recognition processing in a case where the distance to the target object is relatively long.

16. The information processing apparatus according to claim 1, wherein
the recognition unit outputs information related to a region in which the target object in the sensing region is present, as the recognition result.

17. An information processing method to be executed by a computer system, comprising:
a step of acquiring image information and distance information with respect to a sensing region; and
a step of performing integration processing according to a distance to a target object present in the sensing region and recognizing the target object by using the image information and the distance information as an input, wherein
the integration processing is recognition processing in which first recognition processing using the image information as an input and second recognition processing using the distance information as an input are integrated.

18. A program that causes a computer system to execute an information processing method comprising:
a step of acquiring image information and distance information with respect to a sensing region; and
a step of performing integration processing according to a distance to a target object present in the sensing region and recognizing the target object by using the image information and the distance information as an input, wherein
the integration processing is recognition processing in which first recognition processing using the image information as an input and second recognition processing using the distance information as an input are integrated.
